(19) United States
(12) Patent Application Publication
(10) Pub. No.: US 2025/0383870 A1
(43) Pub. Date: Dec. 18, 2025

(54) SYSTEMS AND METHODS FOR LLM-BASED CODE REFACTORING

(71) Applicant: MongoDB, Inc., New York, NY (US)

(72) Inventors: Paul Done, Wokingham (GB); John Harrison Yearsley, Seattle, WA (US); Joerg Schmuecker, Zurick (CH); Sepp Hanes Renfer, Bern (CH)

(21) Appl. No.: 19/235,279

(22) Filed: Jun. 11, 2025

Related U.S. Application Data
(60) Provisional application No. 63/659,270, filed on Jun. 12, 2024.

(51) Int. Cl. G06F 8/72; G06F 8/35; G06F 11/3604

(52) U.S. Cl. CPC G06F 8/72; G06F 8/35; G06F 11/3604

(57) ABSTRACT

In some aspects, a management system is provided that interfaces with software code to execute a refactoring process. The process executes iteratively, where a generative AI component (e.g., an LLM) is given the task to make a repository pass a given validation iteratively. In each step, the LLM in provided as an input a list of failed validations to resolve and the ability to interact with the repository. In some examples, the LLM is configured to read source files, write source files, and retrieves information from other data sources such as the Internet or semantically-indexed source repositories, including the repository that the process is currently operating on, among other operations. Further, external APIs and databases can also be included in the process. The LLM will then execute one or multiple of these operations and process one or multiple files to generate modified and/or new code.

### CROSS-REFERENCE TO RELATED APPLICATIONS

This application claims the benefit under 35 U.S.C. § 119(e) of U.S. Provisional Application No. 63/659,270 entitled “SYSTEMS AND METHODS FOR LLM-BASED CODE REFACTORING,” filed Jun. 12, 2024, the entire contents of which are incorporated herein by reference by its entirety.

### SUMMARY

Aspects described herein relate generally to systems and methods for using generative artificial intelligence (AI) systems (e.g., one or more large language models (LLMs)) to simplify code development, refactoring, transformation, maintenance, and other code-related operations. In particular, according to some embodiments described herein, generative AI systems are integrated into a multi-stage management system which uses multiple validation stages (referred to herein interchangeably as an “oracle”) to accelerate software development, and life cycle operations such as, for example, modernization, migration, re-platforming, refactoring, lifecycle management, functional changes.

In some implementations, it is appreciated that generative AI systems may be leveraged to provide functions associated with refactoring software applications, components and architectures from one development platform and/or framework to another and replacing the database technology. Independent of the changes needed, the same general approach is capable of accelerating the time and effort for the overall transformation project from one set of source code that operates in one environment to source code in another environment. Further, the generative AI system may be used in an iterative manner to detect and handle issues occurring during the refactoring process relating to testing and addressing technical errors and issues during the refactoring process, improving the efficiency of the refactoring process and in some embodiments, it is appreciated that this process can easily be extended to help with general software development.

In one aspect, a computer-based system is provided comprising a management component configured to perform a refactoring of a plurality of code elements; a generative AI component configured to generate code; wherein the management component iteratively call the generative AI component to perform to produce a refactored set of the plurality of code elements, and wherein the management component is configured to use the validate the produced code elements against the various levels of the oracle, and wherein the management component is configured to attempt one or more refactoring attempts based on the verification of the code.

In some embodiments, the management component is adapted to provide a verification output to the generative AI component as a result of an attempted compilation and/or execution. In another embodiment, the management component is configured to stop verification of the code resulting from one or more failed compilation and/or execution attempts.

In some embodiments, the management component is configured to extract one or more compilation error messages. In some embodiments, the management component is configured to build a prompt using the one or more compilation error messages and the generated code. In some embodiments, the management component is configured to provide the prompt to an LLM to generate updated code. In another embodiment, the updated code is compiled and any error results are sent to the management component for refactoring. In some embodiments, the updated code is compiled and if successful, one or more automated test cases are executed by the management component. In some embodiments, the management component is configured to, after detection of errors after attempting a predetermined number of compilation and/or execution attempts, the management component identifies a task to be performed by a human-user.

In some aspects, a computer-based method is provided comprising acts of performing, by a computer system, an automated refactoring of a plurality of code elements into refactored code, generating, by a generative AI component, the refactored code, calling, in an iterative manner, the generative AI component to perform one or more programming functions in an iteration step, performing, at the iteration step, a verification of the refactored code, producing a refactored set of the plurality of code elements and attempting one or more refactoring attempts based on the verification of the refactored code.

In some embodiments, the method further comprises an act of providing a verification output to the generative AI component as a result of an attempted compilation and/or execution. In some embodiments, the method further comprises an act of stopping verification of the code resulting from one or more failed compilation and/or execution attempts. In some embodiments, the method further comprises an act of extracting one or more compilation error messages.

In some embodiments, the method further comprises an act of building, automatically by a management system, a prompt using the one or more compilation error messages and the generated code. In some embodiments, the method further comprises an act of providing, by the management system, the prompt to a Large Language Model (LLM) to generate updated code. In some embodiments, the method further comprises acts of compiling the updated code and sending to the management component any error results to be used for refactoring.

In some embodiments, the method further comprises acts of determining that the updated code is compiled and if successful, executing one or more automated test cases by the management component. In some embodiments, the method further comprises acts of detecting, by the management component, detecting one or more errors after attempting a predetermined number of compilation and/or execution attempts, and identifying by the management component a task to be performed by a human-user. In some embodiments, the method further comprises an act of generating, by the generative AI component, from an inputted source code and refactoring instructions, a destination source code.

Still other aspects, examples, and advantages of these exemplary aspects and examples, are discussed in detail below. Moreover, it is to be understood that both the foregoing information and the following detailed description are merely illustrative examples of various aspects and examples and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

Various aspects of at least one embodiment are discussed herein with reference to the accompanying figures, which are not intended to be drawn to scale. The figures are included to provide illustration and a further understanding of the various aspects and embodiments and are incorporated in and constitute a part of this specification but are not intended as a definition of the limits of the invention. Where technical features in the figures, detailed description or any claim are followed by reference signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure.

### BRIEF DESCRIPTION OF THE DRAWINGS

Various aspects and embodiments will be described with reference to the following figures. It should be appreciated that the figures are not necessarily drawn to scale. Items appearing in multiple figures are indicated by the same or a similar reference number in all the figures in which they appear. The figures are included to provide illustration and a further understanding of the various aspects and embodiments and are incorporated in and constitute a part of this specification but are not intended as a definition of the limits of the invention. Where technical features in the figures, detailed description or any claim are followed by reference signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 shows a distributed computer system in which various aspects may be practiced;

FIG. 2 shows an example process for refactoring code according to various embodiments;

FIG. 3 shows an example process for testing and modifying code according to various embodiments;

FIG. 4 shows an example process for refactoring code according to various embodiments;

FIG. 5 shows an example process for producing code according to various embodiments;

FIG. 6 shows an example multistage process for producing code according to various embodiments; and

FIG. 7 shows an example block diagram of an example special purpose computer system improved by the functions and/or processes disclosed herein.

The figures depict various embodiments of the present invention for purposes of illustration only. One skilled in the art will readily recognize from the following description that other alternative embodiments of the structures and methods illustrated herein may be employed without departing from the principles of the invention described herein.

### DETAILED DESCRIPTION

In some aspects, a management system (referred to herein also as an oracle) is provided that interfaces with software code to execute a refactoring process. Code refactoring is a process of restructuring existing source code to improve its internal structure, readability, and maintainability. The refactoring process generally does not change its external behavior or functionality. In some embodiments, the process executes iteratively, where a generative AI component (e.g., an LLM) is given the task to make a repository pass a given validation oracle iteratively. In each step, the LLM in provided as an input a list of failed validations to resolve and the ability to interact with the repository.

In some embodiments, the LLM is configured to read source files, write source files, and retrieve information from other data sources such as the Internet or semantically-indexed source repositories, including the repository that the process is currently operating on, among other operations. Further, external APIs and databases can also be included in the process. The LLM will then execute one or multiple of these operations and process one or multiple files to generate modified and/or new code. Once the LLM is finished, the validation oracle can be re-run, the output of the oracle will then be captured and fed back into the generative AI component (e.g., the LLM) for further iterations. If the LLM cannot get the repository to pass a given stage of the oracle in a predefined configurable number of executions, in some embodiments, the process will be stopped.

In some embodiments, further correction and testing may be delegated to a human after the process fails at a particular stage. The human can either decide to fix a particular issue completely or partially manually or may leverage a different LLM or other system to correct the issue, before re-engaging the iterative process to continue with the transformation.

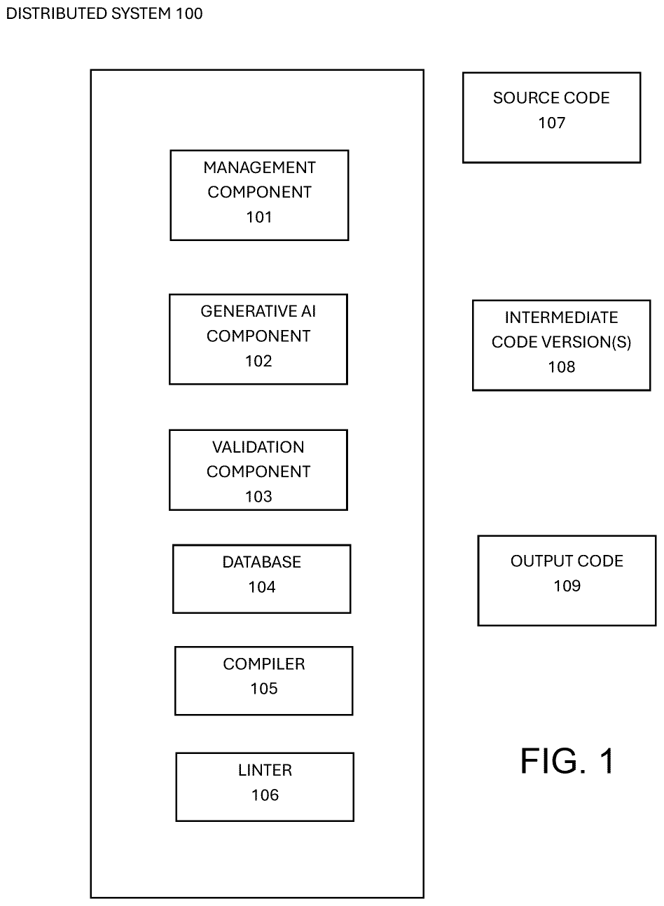

FIG. 1 shows a distributed computer system 100 in which various aspects may be practiced according to various embodiments. In particular, distributed system 100 may include one or more systems, elements, or other types of components that permits software code to be produced, such as through a refactoring process. System 100 may include a management component 101 which is capable of managing a refactoring process by utilizing a number of components to transform code (e.g., source code 107) to an output code (e.g., output code 109). In some embodiments, management component 101 may be configured to iteratively interact with a generative AI component 102 for the purposes of refactoring code.

System 100 may also include one or more validation components 103 which are used to validate any resulting code. The system may also produce one or more intermediate code versions (intermediate code version(s) 108) prior to determining the final version of the output code. System 100 may also include other components such as a database 104, compiler 105, and linter 106 that the management component 101 may call to perform refactoring operations.

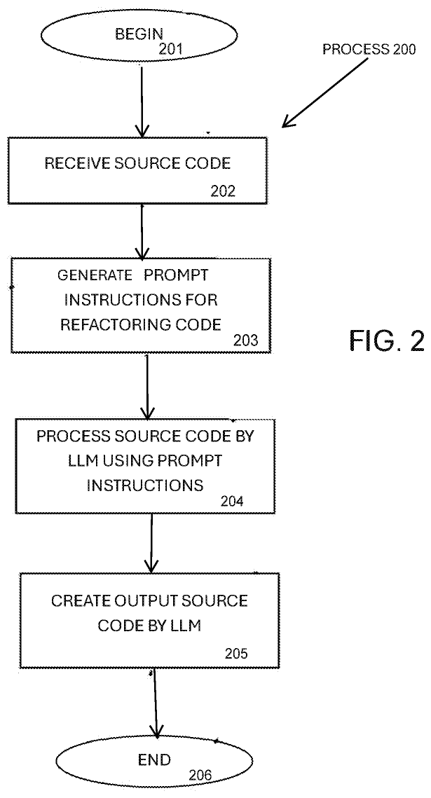

FIG. 2 shows an example process 200 for refactoring code according to various embodiments. For example, process 200 may be executed by a management component (e.g. management component 101) configured to perform a code refactoring operation. At block 201, process 200 begins. At block 202, the management component receives one or more portions of source code to be refactored. The management component 101 may determine one or more prompts at block 203 which are generated to control a generative AI component (e.g., a Large Language Model (LLM)) to perform refactoring operations. At block 204, the LLM processes the one or more portions of source code using the generated prompt instructions. At block 205, the LLM creates output source code and process 200 ends at block 206.

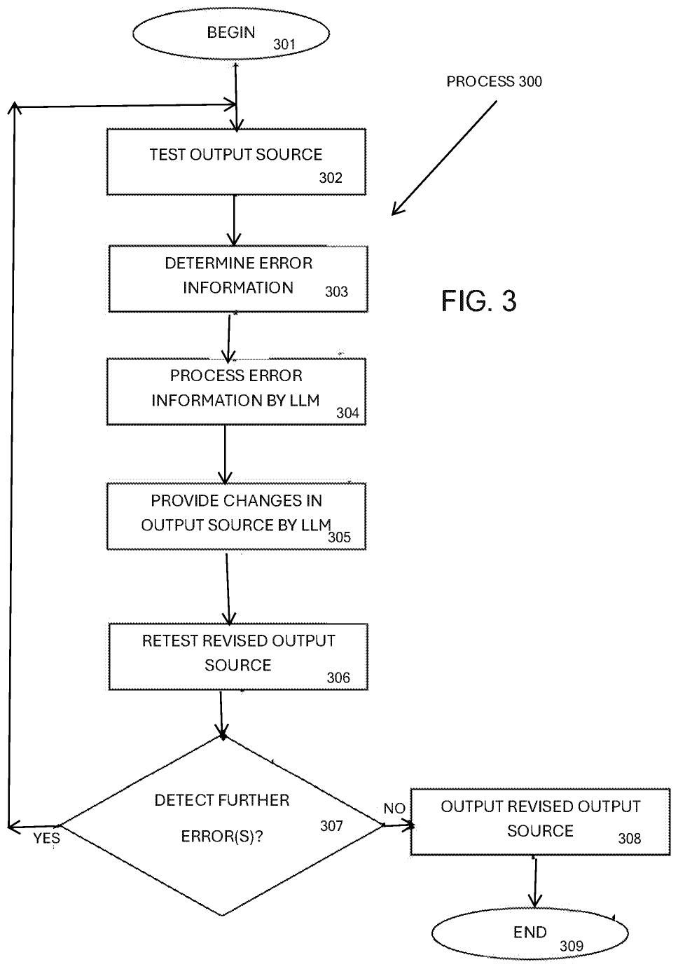

FIG. 3 shows an example process 300 for testing and modifying code according to various embodiments. At block 301, process 300 begins. At block 302, the system tests the output source code. If, during the testing process, it is determined that there one or more errors, the system determines error information (e.g. at block 303). At block 304, the system processes the error information by providing it to the generative AI component (e.g., an LLM). At block 305, the LLM provides changes in the output source which can be then retested at block 306. At block 307 the system determines whether any additional errors have occurred. If no further errors are detected, the system provides revised source code output at block 308. However, if further errors are detected the process is iterative and the code is further revised and tested by performing one or more operations as discussed above. If no further errors are detected, the system outputs the revised output source code at block 308 and process 300 ends at block 309.

It should be appreciated that one or more code types can be refactored using any of the systems, methods, and approaches defined herein. U.S. Provisional Application No. 63/659,270 entitled “SYSTEMS AND METHODS FOR LLM-BASED CODE REFACTORING,” filed Jun. 12, 2024 incorporated herein in its entirety shows various example code implementations according to some embodiments including multiple iterations of refactoring JavaScript code, among other examples.

To trigger the LLM to refactor code towards the correct target, the goal of the refactoring can be injected into the appropriate validation stage. Is the goal to upgrade the version of a given library as part of LCM or security patches, so can this be done by adding a validation stage before the unit tests that validates that the correct version of the library is used in the dependency definition such as the POM in an example shown.

### Multi-Stage Validation Oracle

In some embodiments, a multi-stage oracle may be provided that iteratively validates code using an LLM. In particular, it is appreciated that validation of software systems may be implemented as a multi-stage approach. Validation stages that may be used by the system may include, for example:
1. Compilation
2. Linters
3. Unit tests on local developer machine
4. Tests in a clean environment as part of the ci/cd pipeline
5. Integration tests after pulling changes from main (branch of the source code repository)
6. Technical integration tests after deployment to test environments
7. Functional integration tests in test environment
8. Performance tests
9. Resiliency tests
10. Security tests
11. User acceptance tests (in particular, for user interfaces)

The system may also employ risk reduction strategies such as:
Prod-parallel runs—a specific type of parallel run where both the old (legacy) and new systems are operational in the production environment simultaneously for a period. This allows for a thorough comparison of their performance, correctness, and stability before fully switching to the new system.
Canary deployments—a gradual software deployment strategy where a new version of an application is rolled out to a small subset of users (the “canary group”) before being released to the entire user base. This allows for real-time testing and monitoring in a production-like environment, minimizing risk and potential disruptions.
Red/green deployments—a testing process maintaining two environments: the existing “Red” production environment and the new “Black” environment. Traffic is initially directed to the Red environment, while the Black environment is prepared and tested.

It can also be seen as validation stages for the purpose of executing the process. It should be appreciated that some projects can implement only use a small subset of the potential list of validation methodologies.

In some embodiments, a validation oracle (or component) is provided and includes an automated process that can execute validation steps in the above order and record results of the validation from each step. Depending on the type of validation stage that has been executed, the validation oracle might stop to execute further stages. For example, compiler errors will likely stop the oracle from executing unit tests or any further stages while warning from the compiler or linter do not stop running the tests on the developer's local machine. In some cases, there may be one or more oracles that independently manage different aspects of the code development, and they may communicate to achieve parallel operations relating to code refactoring, migration, or code extension.

In some implementations, the validation oracle requires that the validation steps can be automatically executed or in the case of manual test phases scheduled for execution and provide structured feedback. The exact configuration of the oracle may be highly dependent on the application component.

### Test Generation

Because test coverage is such a crucial part of a generative AI software development process, multiple different test generation capabilities may be implemented to extend functional tests for legacy applications. Such tools can successfully generate automated tests from input/output recordings in different formats when given service APIs for which the tests may be implemented.

### Example Applications

The multi-stage oracle driven approach may be used to refactor an application from one development framework to another, replace a relational database system, extract functionality into microservices implemented on a completely different technology stack. The methodology may be applied to any changes to a software repository that can be validate automatically (at least mostly automatic to obtain performance improvements). As one of the examples, the framework may be used to accelerate the development of new functionality with a TDD (Test Driven Development) approach.

A test may be implemented that verifies that a given functionality was implemented, implemented the path for the functionality and then requests the LLM to create additional test cases before delegating it to a process to implement the necessary functions. While the main focus may include operations such as framework upgrades and replacement of data access layers and replacements of database technologies (e.g., SQL to NoSQL, etc.), the process may be applicable to a wide range of problems in spaces such as:
Lifecycle management, especially platform migrations, version updates for libraries, frameworks, drivers, databases, front-end components
Automated test generation to improve test coverage
Functional software changes

### Modernization Factory Development Process

The following describes an idealized development process for modernization projects. The process is optimized for the use of LLMs but can also be used as part of modern agile software development practices. In some embodiments, the system may depend heavily on automated controls and fast feedback loops.

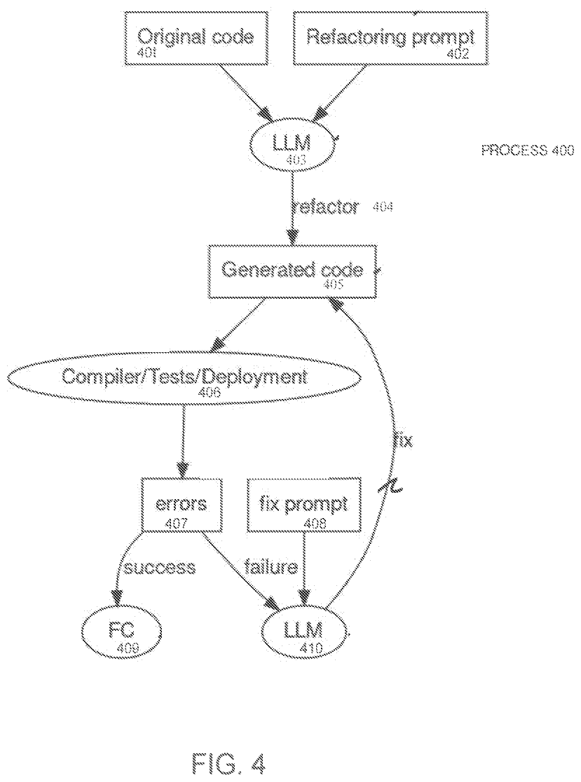

FIG. 4 shows an example for a single generative step. Using a prompt that instructs the LLM (e.g., 403) to refactor 404 the original code (e.g., code 401), process 400 attempts to compile the transformed code (e.g., generated code 405) by a compiler. At block 406, the generated code is compiled, tested and deployed for additional testing. If there are no compiler errors produced (e.g., errors 407), then the LLM has generated code that is able to be compiled. If there are compiler errors, these errors are fed back into a prompt (e.g., fixed prompt 408) that instructs the LLM 410 to fix these errors. This operation creates new code that can be compiled again and this loop is repeated. If after n-loops, the code still does not compile, the whole process including the generation is rerun for m-times. In some embodiments, only if m generations with n iterations in each fixing cycle have not been resulted in code that could be compiled, human interaction is identified by the system as being necessary (e.g., in a message displayed or sent to an operator/user). At block 409, if there are no remaining errors, the final code (FC) is output.

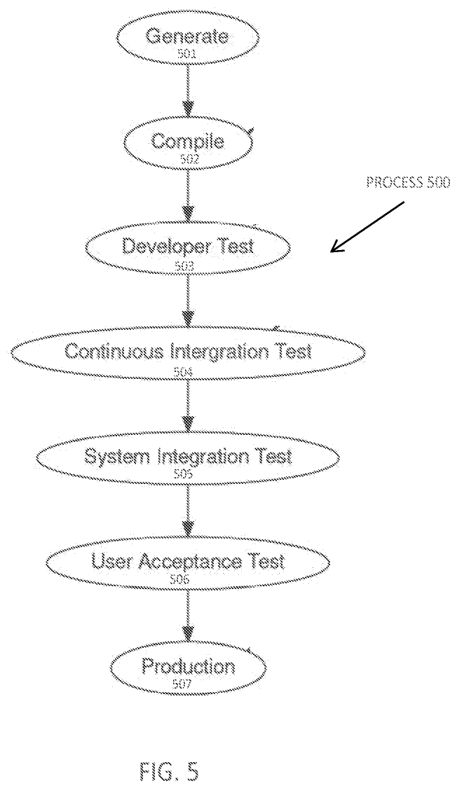

A single generative operation can require multiple fix cycles. FIG. 5 shows an example process 500 for producing code according to various embodiments, the process having a single generative step with control and automatic fixing steps. For example, the system determines generated code at block 511 and compiles the code at block 502. After compiling the code, the developer tests are executed at block 503 and any failed tests are fed back into the LLM with a respective prompt instructing the LLM to fix the problems. Further tests such as continuous integration tests (e.g. continuous integration test 504), system integration tests (e.g., system integration test 505), user acceptance tests (e.g., user acceptance test 506), or other types of tests may be performed, and the code may be iterated further based on the results of those tests. If successful, production code is determined and output (e.g. at production 507).

The process may be characterized as a behavior-driven (BDD) development process. In one implementation, the unit of testing is the whole component and not individual methods, classes, or other unit tests. However, it might be necessary for particularly complicated algorithms to add unit tests to guide the LLM. Such unit tests should not be run as part of the CI/CD pipeline as they are testing implementation details and not behavior.

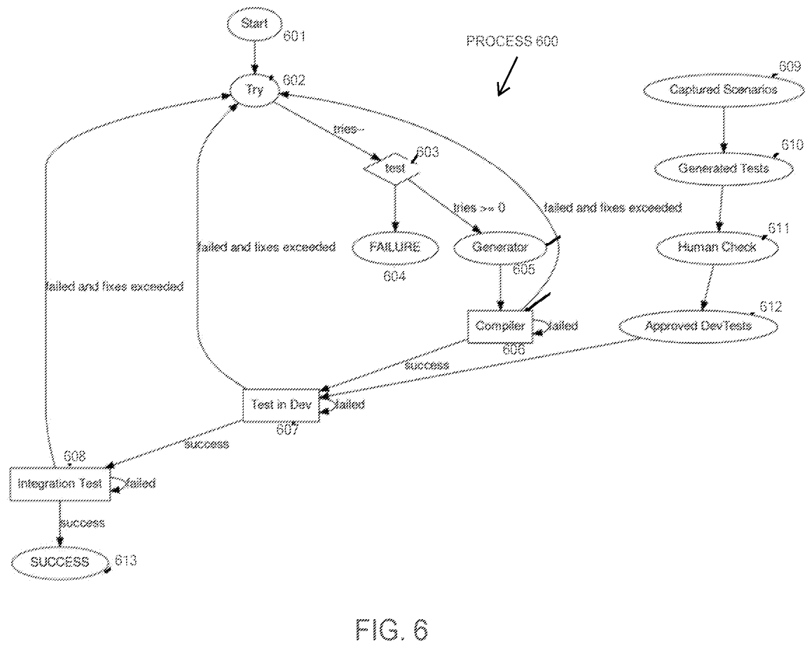

Most projects will have multiple test stages such as those shown in FIG. 6. In particular, FIG. 6 shows an example process for producing code according to various embodiment wherein the process includes multiple test stages. To implement such a multi-stage recursive process, a generic toolkit would be useful. The features may be described as a multi-stage code transformer (MSCT) described in reference to FIG. 6 in more detail below.

### Generation with Controls and Fixes

In some embodiments, the system includes a generator and a number of control stages with fixing mechanisms. The multi-stage code transformer (MSCT) of FIG. 6 generates an artifact and then pass it to the respective control stages. Each control and fix stage can iterate multiple times. If all control stages can be passed, we have successfully generated an artifact. If the generated artifact cannot pass through one of the controls, then the process may be restarted for a number of times. Only if after multiple retries the generation fails, the system may be stopped and mark the operation as failed.

At block 601, process 600 begins. At block 602, the system tries to fix the code and tests at block 603. If the testing fails at block 604 the system tries to make further modifications (e.g., at try block 602). At block 605, the system generates code which can be passed to a compiler at block 606. If the compiler throws an error, the code may be changed (e.g., at try block 602) and tried to be compiled again by the compiler. If failures occur at this level, the code may be changed again (e.g., at try block 602) and then further generates revised code which is then compiled and tested through various stages. If the code is successful, it gets passed to development testing at block 607 where it is tested. In some embodiments, other sources and inputs may be provided to test the code. For example, captured scenarios 609, previous generated tests 610, human checks 611, and approved development tests 612 may be used by the system to modify the code. Finally, if previous stages have passed, and integration test is performed at block 608, and if successful, the system indicates success at block 613 and provides the outputted code. Notably, if any of the tests are failed and exceed some number of tries (e.g., a predetermined number set by user/developer), the system will produce an error and terminate.

Below described different scenarios that the MSCT executes:

### Scenario: Failed Control and Fix Cycle

Given an artifact

When the control generates exceptions

Then the fix prompt is used to generate a new version of the artifact

### Scenario: Successful Control and Fix Cycle

Given an artifact

When the control does not generates exceptions

Then the artifact stays unchanged

### Scenario: Failed Fixing Stage

Given an artifact
When the artifact does not pass the control after n fix cycles
Then the Fixing Stage has failed

### Scenario: Successful Fixing Stage

Given an artifact
When the artifact does pass the control after n fix cycles
Then the Fixing Stage has succeeded
   Scenario: Execution of multi-stage fixing pipeline—retry full pipeline

Given a series of n Fix Cycles and a retry counter R>0
Given the first n-1 stages of the fix cycle have passed

When the n-th stage of the pipeline fails
Then rerun full Generate and QA process with R−1

### Scenario: Failure

Given a Generate and QL process with retry counter R

When R=0

Mark generation as failed

### Scenario: Success

Given a Generate and QL process with retry counter R

Given R>0

Given all n-stages have passed their controls

Mark generation as success

### Migration Example

It should be appreciated that other applications of various aspects may be use that are different than refactoring operations. For example, various techniques described herein can be used to migrate code from one system to another and utilize various testing and code modification functions. In one implementation as shown by way of example in U.S. Provisional Application No. 63/659,270 entitled “SYSTEMS AND METHODS FOR LLM-BASED CODE REFACTORING,” filed Jun. 12, 2024 incorporated herein in its entirety, aspects may be used to assist in a migration from JBoss to a Quarkus implementation. JBoss is an open-source Java-based application server developed by Red Hat. It is a Java Enterprise Edition (Java EE) application server that is used by many customers to deploy their Java applications. Quarkus is a modern, Kubernetes-native Java framework designed for building cloud-native and serverless applications with Java. It should be appreciated that various methods and system aspects described herein may be used for different types of programming languages and other operations different from refactoring.

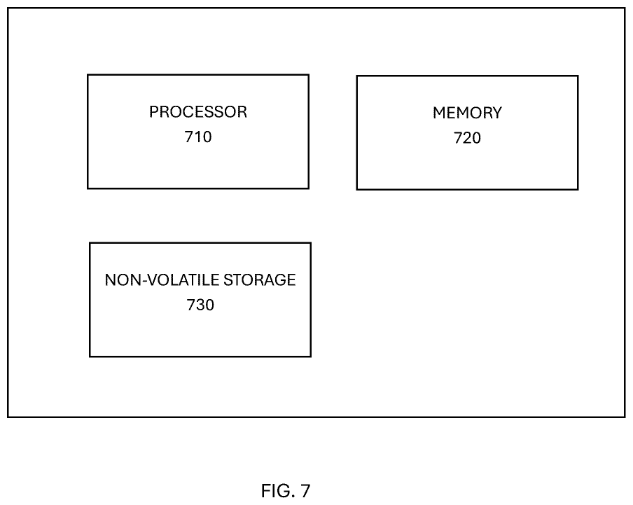

Additionally, an illustrative implementation of a special purpose computer system 700, that may be specially programmed to improve over conventional systems, to be used in connection with any of the embodiments of the disclosure provided herein is shown in FIG. 7. The computer system 700 may include one or more processors 710 and one or more articles of manufacture that comprise non-transitory computer-readable storage media (e.g., memory 720 and one or more non-volatile storage media 730). The processor 710 may control writing data to and reading data from the memory 720 and the non-volatile storage device 730 in any suitable manner. To perform any of the functionality described herein (e.g., secure execution, proxied execution, sandboxed execution, etc.), the processor 710 may execute one or more processor-executable instructions stored in one or more non-transitory computer-readable storage media (e.g., the memory 720), which may serve as non-transitory computer-readable storage media storing processor-executable instructions for execution by the processor 710.

### CONCLUSION

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be understood that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be understood that one implementation of the embodiments of the present invention comprises at least one non-transitory computer-readable storage medium (e.g., a computer memory, a portable memory, a compact disk, etc.) encoded with a computer program (i.e., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be understood that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments. For instance, various additional embodiments that may be implemented are described in Appendix E which forms an integral part of the instant application.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having the same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only and is not intended as limiting. The invention is limited only as defined by the following claims and the equivalents thereto.

What is claimed is:

1. A computer-based system comprising:
a management component configured to perform a refactoring of a plurality of code elements;
a generative AI component configured to generate code;
wherein the management component iteratively calls the generative AI component to perform one or more programming functions in an iteration step; and
wherein the management component is configured to perform, at the iteration step, a verification of the code, producing a refactored set of the plurality of code elements, and wherein the management component is configured to attempt one or more refactoring attempts based on the verification of the code.

2. The computer-based system according to claim 1, wherein the management component is adapted to provide a verification output to the generative AI component as a result of an attempted compilation and/or execution.

3. The computer-based system according to claim 2, wherein the management component is configured to stop verification of the code resulting from one or more failed compilation and/or execution attempts.

4. The computer-based system according to claim 3, wherein the management component is configured to extract one or more compilation error messages.

5. The computer-based system according to claim 4, wherein the management component is configured to build a prompt using the one or more compilation error messages and the generated code.

6. The computer-based system according to claim 5, wherein the management component is configured to provide the prompt to a Large Language Model (LLM) to generate updated code.

7. The computer-based system according to claim 6, wherein the updated code is compiled and any error results are sent to the management component for refactoring.

8. The computer-based system according to claim 6, wherein the updated code is compiled and if successful, one or more automated test cases are executed by the management component.

9. The computer-based system according to claim 7, wherein the management component is configured to, after detection of one or more errors after attempting a predetermined number of compilation and/or execution attempts, the management component identifies a task to be performed by a human-user.

10. The computer-based system according to claim 1, wherein the generative AI component is configured to generate, from an inputted source code and refactoring instructions, a destination source code.

11. A computer-based method comprising acts of:
performing, by a computer system, an automated refactoring of a plurality of code elements into refactored code;
generating, by a generative AI component, generate the refactored code;
calling, in an iterative manner, the generative AI component to perform one or more programming functions in an iteration step;
performing, at the iteration step, a verification of the refactored code, producing a refactored set of the plurality of code elements; and
attempting one or more refactoring attempts based on the verification of the refactored code.

12. The method according to claim 11, further comprising an act of providing a verification output to the generative AI component as a result of an attempted compilation and/or execution.

13. The method according to claim 12, further comprising an act of stopping verification of the code resulting from one or more failed compilation and/or execution attempts.

14. The method according to claim 13, further comprising an act of extracting one or more compilation error messages.

15. The method according to claim 14, further comprising an act of building, automatically by a management system, a prompt using the one or more compilation error messages and the generated code.

16. The method according to claim 15, further comprising an act of providing, by the management system, the prompt to a Large Language Model (LLM) to generate updated code.

17. The method according to claim 16, further comprising acts of compiling the updated code and sending to the management component any error results to be used for refactoring.

18. The method according to claim 16, further comprising acts of determining that the updated code is compiled and if successful, executing one or more automated test cases by the management component.

19. The computer-based system according to claim 17, further comprising acts of detecting, by the management component, detecting one or more errors after attempting a predetermined number of compilation and/or execution attempts, and identifying by the management component a task to be performed by a human-user.

20. The computer-based system according to claim 11, further comprising an act of generating, by the generative AI component, from an inputted source code and refactoring instructions, a destination source code.
